(19) United States
(12) Patent Application Publication
(10) Pub. No.: US 2022/0018151 A1
(43) Pub. Date: Jan. 20, 2022

(54) ROOF TENT CLOSURE MECHANISM

(71) Applicant: CAPAVENTURE - EQUIPAMENTOS PARA LAZER E TEMPOS LIVRES, LDA., Castelo De Paiva (PT)

(72) Inventors: TONY RENÉ PARTENIO, CASTELO DE PAIVA (PT); MÁRIO JOSÉ OLIVEIRA MARTINS, CASTELO DE PAIVA (PT)

(21) Appl. No.: 17/377,333

(22) Filed: Jul. 15, 2021

(30) Foreign Application Priority Data
Jul. 17, 2020 (PT) 11978

(51) Int. Cl. E04H 15/06; E04H 15/58

(52) U.S. Cl. CPC E04H 15/06; E04H 15/58

(57) ABSTRACT

A roof tent closure system designed to facilitate the opening and closing of tent equipment. Both halves of the roof box—front and rear—are equipped with two profiles along the edge and perimeter: the front profile and the rear profile. The front profile is fitted with a locking groove. In turn, the rear profile is fitted with an inward-facing oblique skirt. This oblique skirt, under pressure, slots into the locking groove. A push button is located on the rear profile. Pressing the push button releases the oblique skirt from the locking groove, thereby opening the roof tent.

### CROSS-REFERENCE TO RELATED APPLICATION

This application claims the benefit of Portuguese application no. 11978 filed with INPI on Jul. 17, 2020 in the name of applicant CAPAVENTURE—EQUIPAMENTOS PARA LAZER & TEMPOSE LIVRES, LDA.

### FEDERALLY SPONSORED RESEARCH

Not Applicable

### SEQUENCE LISTING OR PROGRAM

Not Applicable

### BACKGROUND

### Technical Domain

The applicant for this patent is a leading company in a highly specialised market niche: the roof tent sector.

Within this scope, the company has developed solutions designed to provide users (generally drivers of all-terrain vehicles who enjoy camping and caravanning) with an increasingly pleasant and innovative experiences.

While the shape of these tents (in closed mode), to be put in place and transported, is an important factor due to the aerodynamic requirements involved, the manufacturer/applicant has focused on the ease of use of the equipment.

As such, the inventor has developed an innovative process for opening and closing roof tents: simpler, easier and more practical, in addition to providing aesthetic advantages.

The type of tent the invention refers to are highly specific objects, where either the general shape (to prevent any increase in friction) or the specific design (they are mounted and complement the lines of the motor vehicle) are fundamental aspects to be taken into account. This is in addition to the need for these devices to be practical, guaranteeing easy assembly, convenient use and rapid dismantling and storage.

Thus, the need arose to increase levels of comfort and ease in opening and closing the aforementioned roof tents.

Indeed, the invention consists of a solution in which, instead of a normal zipper closure system or, in place of hinges, clips, springs and similar solutions, there are two half-profiles along the edges of each half of the roof tent. The configuration of the profiles has been designed in such a way that they slot in, closing the tent, on the application of pressure. To open the tent—releasing the profiles,—all you need to do is press a button, concealed on the outside of the equipment, which in turn presses one of the profiles.

### State of the Art

The current state of the art with regard to opening and closing roof tents features traditional solutions including buckles, snap springs, etc.

Zipper closures would be a configurable solution, but they are not particularly appropriate for structures as rigid and relatively heavy and bulky as roof tents.

Roof tents are of a significant size and are generally mounted on off-road vehicles and attain a considerable height. Hence, a ladder is required to enable the user to open, assemble, dismantle and close this type of tent. This procedure can be time-consuming and uncomfortable.

The invention in question provides a simpler, easier, more convenient and efficient solution for this process of assembling and disassembling roof tents.

### SUMMARY

This is a new roof tent closure system designed to facilitate the opening and closing of this type of equipment. Both halves of the roof box—front and rear—are equipped with two profiles along the edge and perimeter: the front profile and the rear profile. The front profile is fitted with a locking groove. In turn, the rear profile is fitted with an inward-facing oblique skirt. This oblique skirt, under pressure, slots into the locking groove. A push button is located on the rear profile. Pressing the push button releases the oblique skirt from the locking groove, thereby opening the roof tent.

### DRAWINGS

FIG. 1 illustrates a cross-section view of the two parts of the roof tent (1), with the front profile (2), the rear profile (3) and the push button (4). Both the inward-facing oblique skirt (3-a) on the rear profile (3) and the locking groove (2-a) on the outer edge of the front profile (2) are visible;

FIG. 2 illustrates a cross-section view of the two parts of the roof tent (1), when connecting the front profile (2) and the rear profile (3), where the push button is visible (4) and showing both the oblique skirt (3-a) on the rear profile (3) slotting into the locking groove (2-a) in the front profile (2);

FIG. 3 illustrates a cross-section view of the closed roof tent (1), showing the rear profile (3) equipped with an oblique inward-facing skirt (3-a) slotted into the locking groove (2-a) in the front profile (2) and the push-button (4).

### DESCRIPTION

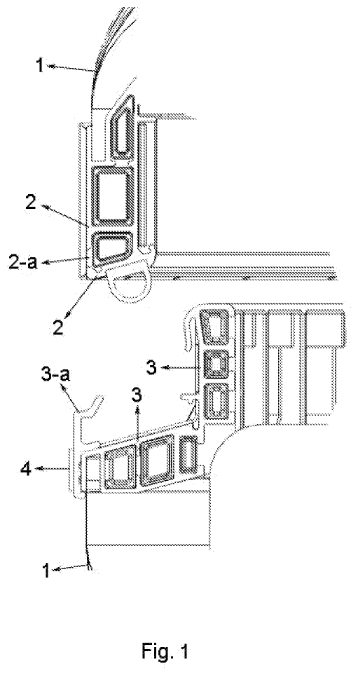

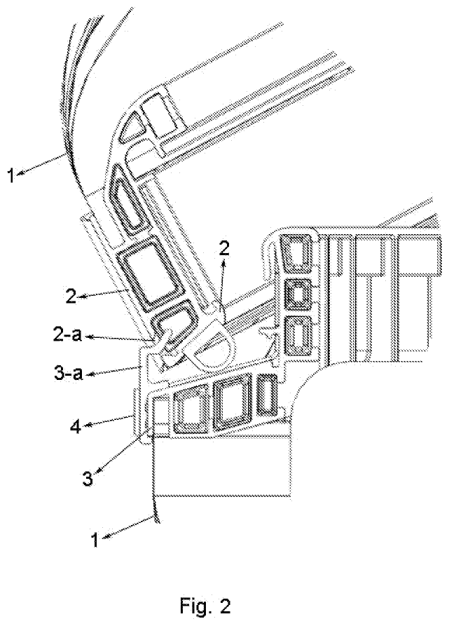

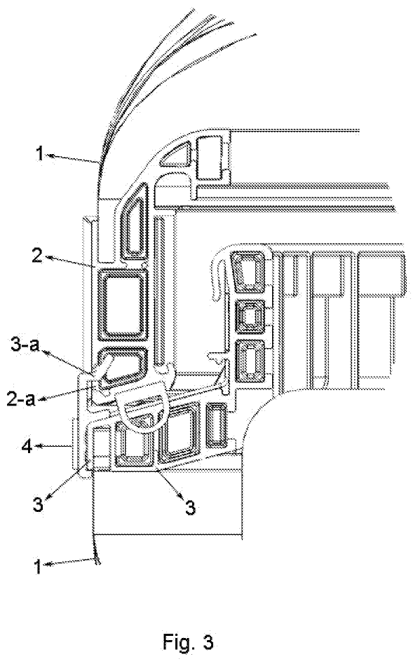

The invention basically consists of:
Placing profiles on the outer edges of the two halves of the roof tent (FIG. 1 to FIG. 3);
A pronounced skirt on the edge of one of the profiles and a groove in the lower edge of the other profile;
A push button (ideally, two units placed on the front of the equipment close to the corners);
Simply pressing the button, releasing the rear profile from the front profile and thereby opening the roof tent.

In order to get the best out of the invention, the profiles should be placed on three sides of the roof tent, whereby one of the sides is fixed to the structure (using hinges, for example) and the equipment can only be opened through the profiled area. Alternatively, the profiles can be placed along the entire perimeter of the roof tent, with one half being totally separated from the other by simply pressing buttons located along its perimeter.

A front profile (2) is mounted on the edge of the upper half of the roof tent (1). This profile is fitted with a locking groove (2-a) designed to enable the two profiles to fit together.

In fact, the rear profile (3)—mounted on the edge of the lower half of the roof tent (1)—features a pronounced oblique skirt (3-a) facing the inside of the tent.

The shape and position of this oblique skirt (3-a) allows it to slot into, under slight pressure, the locking groove (2-a) in the front profile (2).

Once the roof tent (1), as illustrated in FIG. 1, is closed, the two halves are hermetically joined. To open the tent, simply press the push button (4) which, in turn, releases the oblique skirt (3-a) from the locking groove (2-a).

In order to get the best out of the invention—while not limiting the technical bases—the profiles should be made of polymeric material to allow for some flexibility.

The oblique skirt (3-a) can have a different configuration, provided it slots into and tightly fits the locking groove (2-a) in the other profile.

Applying pressure to the two halves of the roof tent using the surrounding profiles will close it; Applying slight pressure to the push button (4) will open the tent and speed up the assembly process.

Thus, we have a practical, convenient and simple solution with clear benefits for users of roof tents.

What is claimed:

1- A roof tent closure mechanism comprising a roof tent (1), made up of two halves, with a front profile (2) and a rear profile (3) along an edge. The front profile (2) features a locking groove (2-a), and the rear profile (3) features an oblique skirt (3-a), which slots into said locking groove, in addition to a push button (4) in several places on the rear profile (3).
